(19) United States
(12) Patent Application Publication
(10) Pub. No.: US 2020/0302263 A1
(43) Pub. Date: Sep. 24, 2020

(54) BOT SYSTEMS AND METHODS

(71) Applicant: Life-Dash, LLC, San Diego, CA (US)

(72) Inventor: Keren Douek, San Diego, CA (US)

(21) Appl. No.: 16/825,401

(22) Filed: Mar. 20, 2020

Related U.S. Application Data
(60) Provisional application No. 62/821,483, filed on Mar. 21, 2019.

(51) Int. Cl. G06N 3/00; G06N 20/00; G06N 5/04

(52) U.S. Cl. CPC G06N 3/006; G06Q 50/01; G06N 5/04; G06N 20/00

(57) ABSTRACT

A bot service to enable personalized interactions/communications with a user and a consistent uninterrupted experience with recall from one tech apparatus (e.g., app, device, bot, dash, etc.) to the next.

### CROSS-REFERENCE TO RELATED APPLICATIONS

This application claims priority to U.S. Provisional Patent Application Ser. No. 62/821,483, filed on Mar. 21, 2019, entitled “BOT SYSTEMS AND METHODS,” currently pending, the entire disclosure of which is incorporated herein by reference.

### FIELD

The field relates to bots (e.g., chatbots, etc.), and more particularly to systems and methods for enabling a user to select a bot to serve as an authenticated agent (e.g., artificial intelligence (AI) representative, etc.), including to other authenticated bot agents within a network of authenticated bot agents with decentralized identity protection.

### BACKGROUND

Bots (e.g., chatbots, etc.) are computer-based conversational agents/entities, having artificial intelligence, that are designed to conduct a human conversation (i.e., a “chat”) with users. For example, bots respond to inputs from users in a manner that drives the conversation forward to achieve a goal or task of the user, thus giving the illusion to the user that the bot understands the user. In this manner, bots seek to simulate how a human would interact with the user. Bots can also undertake certain tasks on behalf of the human user. Conventional bot techniques suffer from drawbacks such as inconsistency from one computing device/interaction channel to the next and inconsistency from one bot to the next. Moreover, different conventional bots utilize different user interfaces that are inconsistent and can confuse and frustrate users. Conventional bots are unable to recall details between sessions and/or devices and thus users must start over with each new device, app, or the like. Conventional bots are also limited in their ability to build trust with users because they are generally impersonal, responsive but not proactive, and suffer from drawbacks such as inconsistency and lack of recall between sessions and across devices, thus inhibiting a “relationship” between user and bot.

### SUMMARY

A bot service to enable personalized interactions/communications with a user and a consistent uninterrupted experience with recall from one tech apparatus (e.g., app, device, bot, dash, etc.) to the next.

In an example embodiment, a method includes receiving user data. The user data includes data representing an online presence of the user. The user data is analyzed and a personality hypothesis is generated for the user based on the analyzed user data. A user persona is created for the user based at least in part on the generated personality hypothesis. A personalized bot is created for the user based on the user persona. The personalized bot personalizes at least a user interface, a language, a personality, and a user journey specifically to the user. The personalized bot is continually updated based on interactions between the personalized bot and the user.

In another example embodiment, a method includes receiving data from a user. A user persona is created for the user based on the received data. The received data is analyzed to determine at least one communication style of the user and at least one learning style of the user. A personalized bot is created for the user based on the user persona, the communication style of the user, and the learning style of the user. Interactions between the personalized bot and the user are filtered. The filtering includes altering properties of the interactions such that the interactions are most compatible to the user persona, the communication style of the user, and the learning style of the user. The personalized bot interacts with the user via the filtered interactions.

### BRIEF DESCRIPTION OF THE DRAWINGS

FIGS. 1A and 1B illustrate block diagrams of an exemplary system according to an embodiment.

FIG. 2 illustrates a block diagram of an exemplary method performable by the exemplary system of FIGS. 1A and 1B according to an embodiment.

FIG. 3 illustrates aspects of a conversational user interface of the exemplary system of FIGS. 1A and 1B and the exemplary method of FIG. 2 according to an embodiment.

FIG. 4 illustrates aspects of seamless live agent takeover and bot backup team of the exemplary system of FIGS. 1A and 1B and the exemplary method of FIG. 2 according to an embodiment.

FIG. 5 illustrates aspects of personalized decision trees and self/supervised learning of the exemplary system of FIGS. 1A and 1B and the exemplary method of FIG. 2 according to an embodiment.

FIG. 6 illustrates aspects of Myers-Briggs Type Indicators of the exemplary system of FIGS. 1A and 1B and the exemplary method of FIG. 2 according to an embodiment.

FIG. 7 illustrates aspects of pulling in data from external sources of the exemplary system of FIGS. 1A and 1B and the exemplary method of FIG. 2 according to an embodiment.

FIG. 8 illustrates aspects of generating a user persona of the exemplary system of FIGS. 1A and 1B and the exemplary method of FIG. 2 according to an embodiment.

FIG. 9 illustrates aspects of a personalized seamless bot interacting with a user of the exemplary system of FIGS. 1A and 1B and the exemplary method of FIG. 2 according to an embodiment.

FIG. 10 illustrates aspects of the personalized seamless bot functioning as a buffer of the exemplary system of FIGS. 1A and 1B and the exemplary method of FIG. 2 according to an embodiment.

FIG. 11A illustrates aspects of another exemplary method performable by the exemplary system of FIGS. 1A and 1B according to an embodiment.

FIG. 11B illustrates an exemplary graphical user interface dashboard of the exemplary system of FIGS. 1A and 1B according to an embodiment.

FIG. 11C illustrates a block diagram of another exemplary method performable by the exemplary system of FIGS. 1A and 1B according to an embodiment.

FIG. 11D further illustrates aspects of the exemplary system of FIGS. 1A and 1B according to an embodiment.

FIG. 11E illustrates a block diagram of another exemplary method performable by the exemplary system of FIGS. 1A and 1B according to an embodiment.

FIGS. 11F and 11G illustrate aspects of the exemplary method of FIG. 11E.

FIG. 12 is a block diagram of an exemplary embodiment of a computer system upon which aspects of the systems and methods described herein can execute.

### DETAILED DESCRIPTION

A bot service to enable a consistent uninterrupted experience with recall from one tech apparatus (e.g., app, device, bot, dash, etc.) to the next, delivered through a user-friendly bot is described herein. In an aspect, the bot service is built for novice users and is consumer-facing. In a further aspect, the bot service plus an optional live agent with session-to-session recall enables the bot service to build a relationship with the user, analyze interactions plus other available data and create a dynamic ever-evolving user profile, to which the bot service adapts its user experience (UX) as well as command center UX around user's complete DNA/persona, user's stated preferences, and preferences inferred from interactions and available data. In an embodiment, the bot service integrates with a plurality of technology apparatuses utilized by the user (i.e., user's “tech”), such as apps, devices, bots, dashboards, and the like, essentially becoming a buffer across the plurality of technology apparatuses utilized by the user, providing the user with a consistent, uninterrupted user experience with recall from session to session and technology apparatus to technology apparatus. As the user's confidence score in its personalized bot grows, the personalized bot takes on more and more responsibility, stepping in as a representative, negotiator, advocate, teacher, and friend, as needed. In some embodiments, the user may be referred to as a botist.

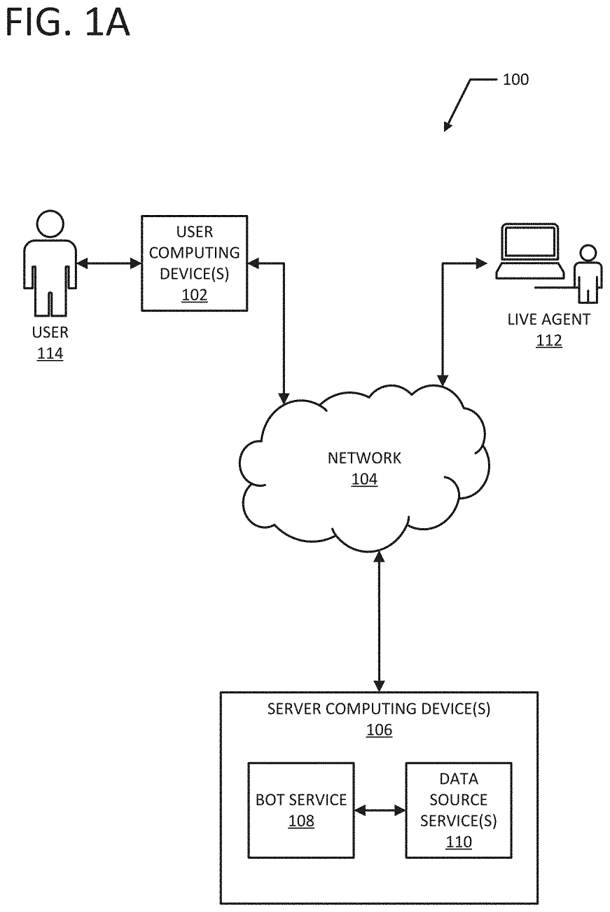

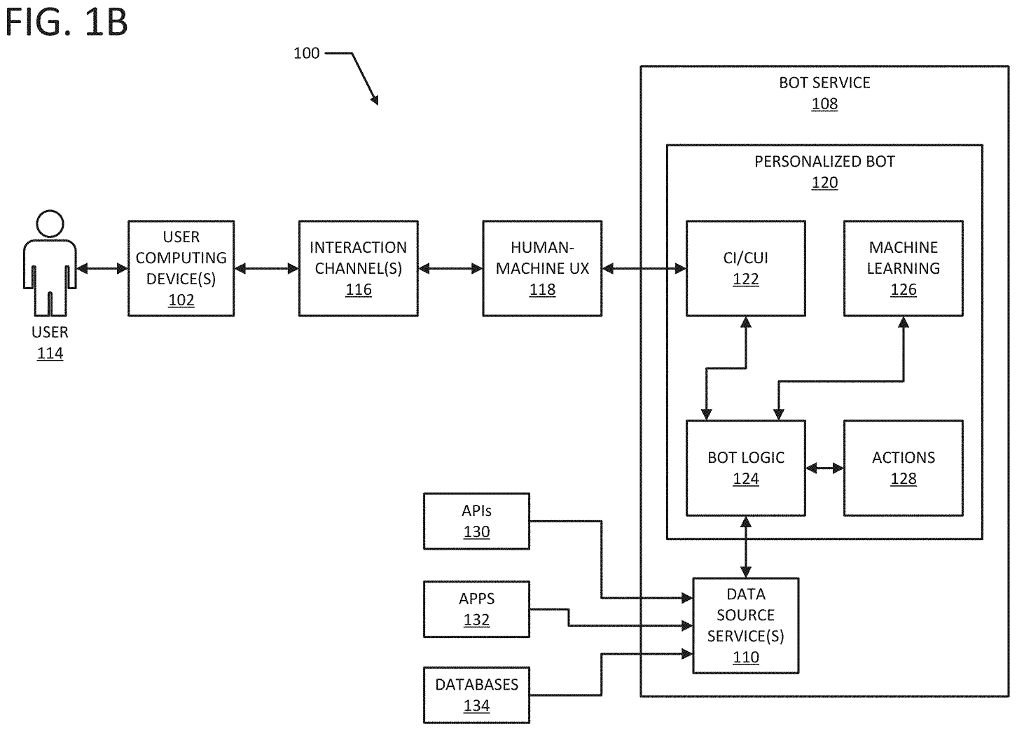

FIGS. 1A and 1B are block diagrams of aspects of a system 100, according to an exemplary embodiment. Referring further to FIG. 1A, the system 100 includes one or more user computing devices 102, a network 104, and one or more server computing devices 106. A bot service 108 and one or more data source services 110 execute on the one or more server computing devices 106. The system 100 may also include a live agent 112. A user 114 interacts with the system 100 via the one or more user computing devices 102. Although a single user is illustrated in FIGS. 1A and 1B for simplicity, those skilled in the art will understand that system 100 may be used concurrently by a plurality of users 114 each interacting with their respective one or more user computing devices 102. Referring further to FIG. 1B, the user 114 utilizes the user computing devices 102 to interact with the bot service 108 via one or more interaction channels 116 that each have their own human-machine user experience (UX) 118. The bot service 108 generates a personalized bot 120 that is personalized/customized for the user 114. Each personalized bot 120 includes a conversational user interface (Cl/CUI) 122, bot logic 124, machine learning algorithms 126, and actions 128. The data source services 110 collect data from various data sources via application programming interfaces (APIs) 130, apps 132, and/or databases 134, for example.

The one or more user computing devices 102 are each operable to provide a user interface to enable the user 114 to interact with aspects of system 100, particularly the bot service 108. An exemplary user interface includes a conversational user interface (CI/CUI), which uncovers user intent through a variety of conversational interfaces (e.g., text-based chat, voice, etc.) and graphical user interface elements (e.g., buttons, images, menus, videos, etc.). Unlike natural language processing (NLP), which focuses on understanding what the user is saying, CI focuses on providing what users need via a personalized experience. Exemplary user computing devices 102 include, but are not limited to, smartphones, tablet computing devices, laptop computing devices, desktop computing devices, Internet of Things (IoT) devices, smart speakers, smart televisions, smartwatches, smart appliances, in-vehicle infotainment (IVI) systems, telephones, and the like.

The network 104 is capable of facilitating the exchange of data among the computing devices that comprise the exemplary system 100 (e.g., user computing devices 102, server computing devices 106, live agent computing device 112, etc.). The network 104 in the embodiment of FIG. 1A includes a wide area network (WAN) that is connectable to other telecommunications networks, including other WANs, local area networks (LANs), or portions of the Internet or an intranet. The network 104 may be any telecommunications network that facilitates the exchange of data, such as those that operate according to the IEEE 802.3 (e.g., Ethernet) and/or the IEEE 802.11 (e.g., Wi-Fi) protocols, for example. In another embodiment, network 104 is any medium that allows data to be physically transferred through serial or parallel communication channels (e.g., copper wire, optical fiber, computer bus, wireless communication channel, etc.).

The one or more server computing devices 106 are operable to execute the bot service 108 and data source services 110 to provide bot service functions for the user 114 via the user computing devices 102.

The bot service 108 is operable to engage the user 114 and analyze all interactions as well as available data to continually develop a dynamic user profile (e.g., personalized bot 120) that includes but is not limited to personality properties of the user 114 (e.g., Myers-Briggs Type Indicator (MBTI), etc.), a social/web presence of the user 114, and technology apparatuses of the user 114. In some embodiments, the user profile may be referred to as a user persona or user DNA. The bot service 108 continuously engages the user 114, and continuously checks and confirms or edits the user's personalized bot 120 via interaction analysis or any new data that arises during operation of the bot service 108. The bot service 108 adapts its complete user experience (UX), as well as the UX of its command center, based on what it learns of the user 114. The bot service 108 learns the user's best learning style, learning habits, the apps available to user, and the like, and generates a complete, personalized step-by-step program for the user to achieve goals. In an embodiment, the personalized bot 120 developed for a particular user 114 may be referred to as a filter (e.g., a custom bot filter for extreme personalization), as further described herein.

The data source services 110 are operable to enable the bot service 108 to collect data about the user 114 separate from interactions between the user and the bot service 108. Exemplary data source services 110 include, but are not limited to, social media, tools that analyze the user's social media (e.g., Crystal, etc.), a listing of apps utilized by the user, forms, financial/financial services information, identity management, other bots, dashboards, notifications, and the like. The data source services 110 can collect data about the user 114 via APIs 130, apps 132, and/or databases 134.

The live agent 112 is available to perform interactions (e.g., answer questions, etc.) with the user 114 that the personalized bot 120 is unable to adequately perform. In an embodiment, the personalized bot 120 transfers user interactions to the live agent 112 without notifying the user 114. The live agent 112 utilizes a user profile of the user 114, generated by the personalized bot 120, to interact with the user in a manner that is consistent with the profile of the user. The user interactions can be transferred back to the personalized bot 120 without notifying the user 114. In this manner, the bot service 108 seamlessly (e.g., from the viewpoint of the user) transitions interactions between the personalized bot 120 and the live agent 112.

The user 114 utilizes the user computing devices 102 to interact with the bot service 108 via one or more interaction channels 116 that each have their own human-machine user experience (UX) 118. Exemplary interaction channels include, but are not limited to, messaging platforms, Facebook® messenger, Slack, WhatsApp, Kik, Google® Allo, iMessage, and the like. The UX experiences 118 for each interaction channel 116 include properties that can be customized, such as colors, layout, spacing, language, and the like.

The bot logic 124 is operable to provide automated answers and branching logic. In an embodiment, the bot logic 124 is configured in an administrator panel (e.g., a GUI dashboard, etc.). In an embodiment, the bot logic 124 is scripted. In an embodiment, first the bot logic 124 first operates to perform interactions with the user 114 using automated answers and branching logic, and live agents 112 on standby. When the bot logic 124 encounters an interaction with the user 114 that it cannot handle with the automated answers and branching logic, the bot service 108 transfers the user interaction to a live agent 112. The live agent 112 handles the user interaction until the interaction reaches a state in which the bot logic 124 can resume the interaction. In an embodiment, the live agent 112 redirects to the user interaction to a new storyline within the bot logic 124.

The machine learning algorithms 126 are operable to learn (e.g., learn the user persona for the user 114, etc.) and improve interactions with the user 114 without being explicitly programmed. In an embodiment, the machine learning algorithms 126 are designed for user interactions that the bot logic 124 cannot adequately handle. In an embodiment, script writers (e.g., live agents 112, etc.) develop new branches (e.g., one of actions 128), bots (e.g., personalized bots 120) send users through, bots call in agents (e.g., live agents 112) as a user interaction enters a state in which the bot logic 124 cannot handle the interaction, and experts interpret the data the develop new branches (e.g., one of actions 128). For example, the experts may interpret the data to determine why the user interaction is entering a state in which the bot logic 124 cannot adequately handle the interaction, who are the users whose interactions are ending up on this branch, and whether a new user profile (or persona) is needed.

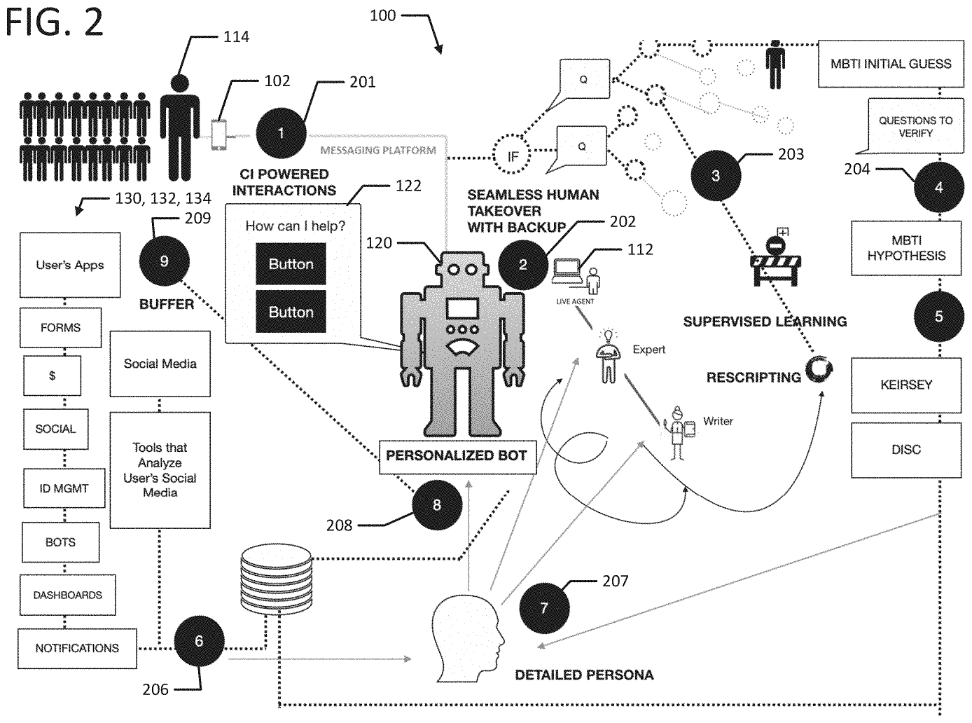

FIG. 2 illustrates an exemplary embodiment of system 100 and associated methods performed by system 100 for providing the personalized bot 120 with a consistent uninterrupted experience with recall from one technology apparatus (e.g., app, device, bot, dash, etc.) to the next, delivered through a user-friendly bot. As illustrated, the personalized bot 120 interacts with the user 114 at 201, analyzes interactions and available data about the user to continually develop a dynamic user profile (i.e., a “persona”) at 202, 203, 204, 206, and 207 that includes, but is not limited to, a user DNA (including MBTI)/personality profile, social/web presence, and the user's complete “tech” (e.g., app usage, devices, etc.). The personalized bot 120 continuously checks and confirms or edit's the user's DNA via interaction analysis and/or any new data that becomes available. The personalized bot 120 adapts the complete UX to the user's DNA and expressed and learned preferences, including but not limited to, the dashboard/command center of the personalized bot 120. The personalized bot 120 correlates the personality type and complete user profile (new name/DNA) to the user's learning style, the user's jobs, the user's interrelations, and the like. The personalized bot 120 learns the user's best learning style, learning habits, the apps available to the user, and the like to generate a complete, personalized step-by-step program for the user to achieve goals. In an embodiment, the personalized bot 120 developed for a particular user may be a filter (e.g., a custom bot filter for extreme personalization), as further described herein, for personalizing its properties and the properties of its interactions with the user into form(s) most compatible to the user's persona, communication style, and learning style and for integrating and filtering live agent commands and third party intelligence and actions through a seamless uninterrupted personalized bot experience. The personalized bot 120 starts to serve as a buffer, at 209, between the user and the user's tech, to bring a consistent and personalized UX experience based on the user's unique DNA and learning style. In some embodiments, the personalized bot 120 functions as a representative/negotiator/advocate on behalf of the user.

The personalized bot 120 engages the user and analyzes interactions. Almost any user information can be used as a starting point toward generating the user's personality/MBTI profile (i.e., persona). In some embodiments, the personalized bot 120 can identify an MBTI “starting point” in 60 seconds or less based on a set of questions. Virtually any information on the user could be used as a starting point. A starting point, for example, is job title, on which there is MBTI data. Simply by asking user's job title, the personalized bot 120 begins to sketch an estimated persona, albeit with a low confidence score to start.

Adding other available data. Crystal is an example source of data. After generating the starting point persona, the persona can be refined and added to with research over time based on data from other sources.

The personalized bot 120 can keep the user engaged over time and build an actual relationship with the user and thus the bot 120 can generate a detailed user profile. The user profile can include:
i. Personality (including but not limited to MBTI)
MBTI/personality profile—the personalized bot 120 can initially take a guess, and over time confirm or edit that guess and hone in on it more specifically, or eventually come up with a much more detailed analysis than MBTI, based on available data to be uncovered by the personalized bot 120 over time
ii. Social/Web presence
iii. User's complete ‘tech’=app usage, connected devices, integrated apps . . .
To continually develop a dynamic user profile/DNA

Initially, the user is given a basic assessment based on interactions and available data, and then tested further to confirm or edit that prediction, and then the personalized bot 120 continuously checks and confirms or edits user's DNA/PERSONA and confidence score via Interaction Analysis and any new data that comes in. For example, if the personalized bot 120 is 84% certain user is INTJ at start, that confidence should grow as the personalized bot 120 continues to interact with the user and analyze interactions and any new data against hypothesized profile. In an embodiment, the personalized bot 120 can create 16 storylines corresponding to the 16 MBTI types. Each storyline takes the user through additional questions to verify or hone in on their persona.

The personalized bot 120 adapts the complete UX to the user's DNA/persona and expressed and learned preferences. The personalized bot 120 designs itself and its corresponding dashboard based on the user's particular preferences. These can be expressed preferences (the user can log in and control the preferences in settings), but by default they are built based on the user's ever-growing DNA/persona. Exemplary UX preferences based on the user's full DNA/persona include, but are not limited to, colors, images, spaces, calendar settings, mailbox settings, and the like. A user portal that enables the user to manage his or her “tech” appears as a dashboard/command center of the personalized bot 120 in an embodiment.

Relationship ensues. The personalized bot 120 can build a meaningful relationship with the user. Conventional systems do not provide such relationships because there is no recall between sessions and/or devices.

In an embodiment, the personalized bot 120 serves as a buffer between the user and user's tech, to provide a consistent and personalized UX experience based on the user's unique DNA/persona and learning style. The personalized bot 120 provides a united front to users in an embodiment.

In another embodiment, the personalized bot 120 provides the user a consistent experience across the user's “tech”. Consistency in user interface design helps to constantly prove a user's assumptions, creates a sense of control, and increases usability.

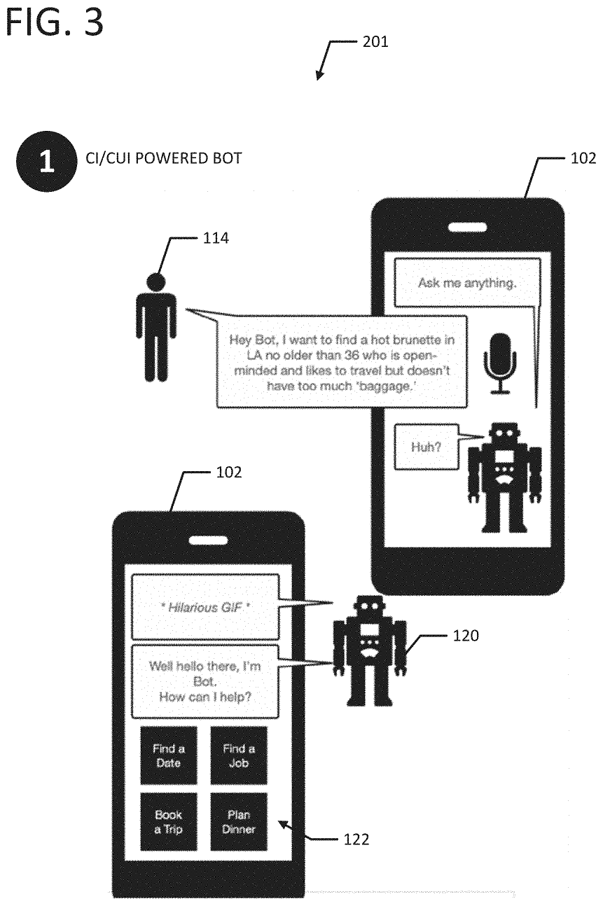

FIG. 3 illustrates additional details regarding the CUI of the bot service 108 and interactions 201 with the user 114. In an embodiment, the bot service 108 utilizes a conversational user interface (Cl/CUI) on the user computing device 102, which uncovers user intent through a plurality of conversational interfaces (e.g., chat, voice, etc.) and graphical user interface elements (e.g., buttons, images, menus, videos, etc.). In an aspect, the conversational user interface enables the bot service 108 to focus on providing assistance to users via a personalized experience (e.g., personalized bot 120, etc.).

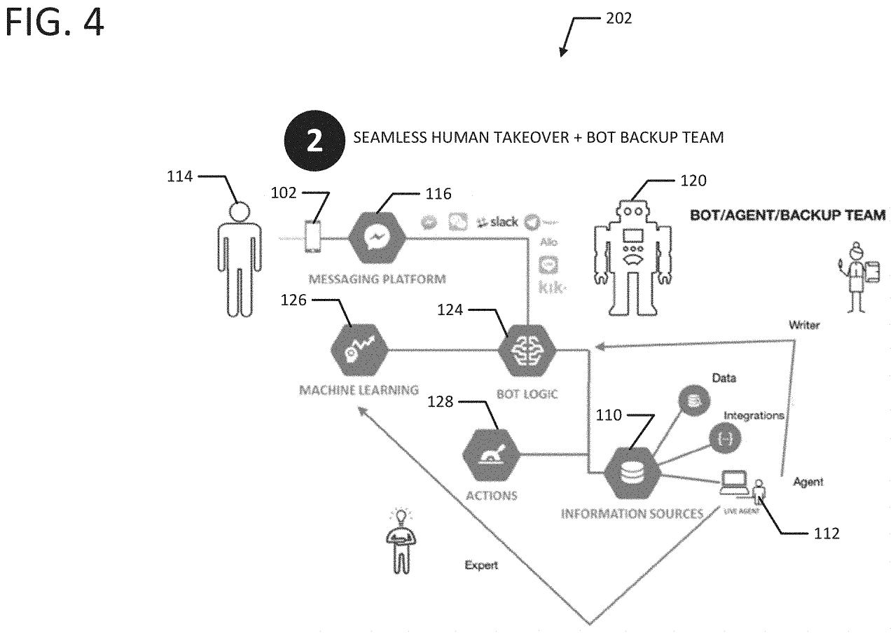

FIG. 4 illustrates additional details regarding the live agent takeover 202 and bot backup team of the bot service 108. As illustrated, information from the live agent 112 and/or an expert is provided as feedback to the bot logic 124 and/or the machine learning algorithms 126.

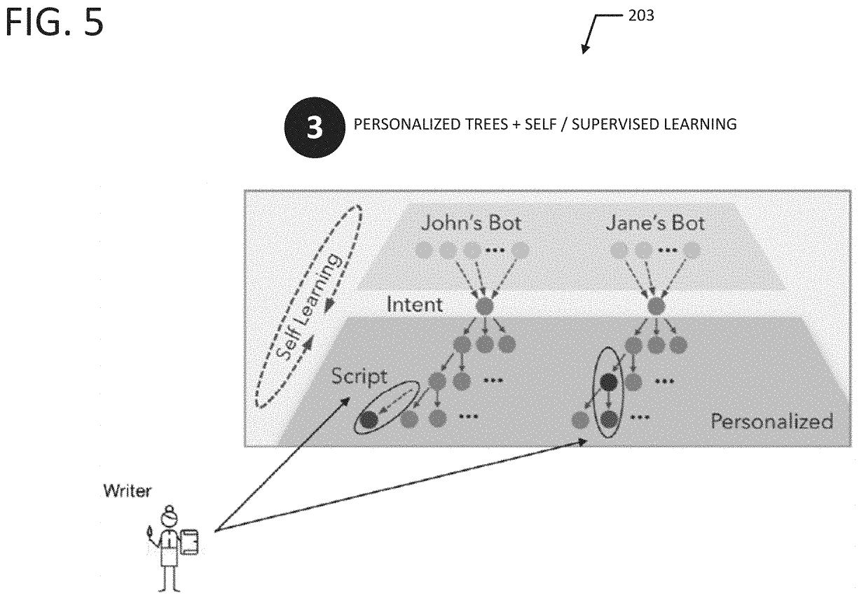

FIG. 5 illustrates additional details regarding the personalized decision trees and self/supervised learning 203 of the bot service 108.

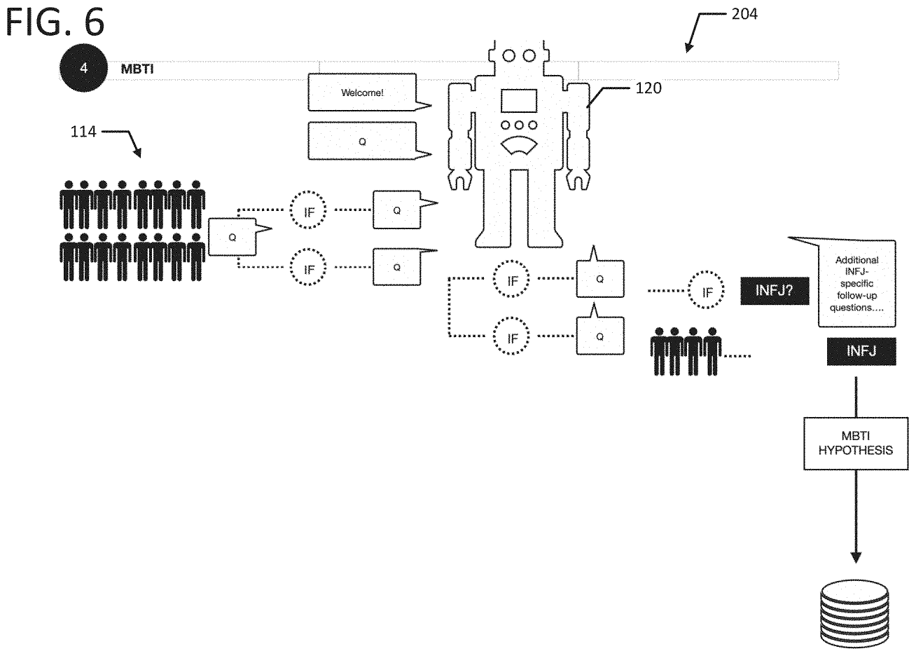

FIG. 6 illustrates additional details regarding utilization 204 of Myers-Briggs Type Indicator by the bot service 108.

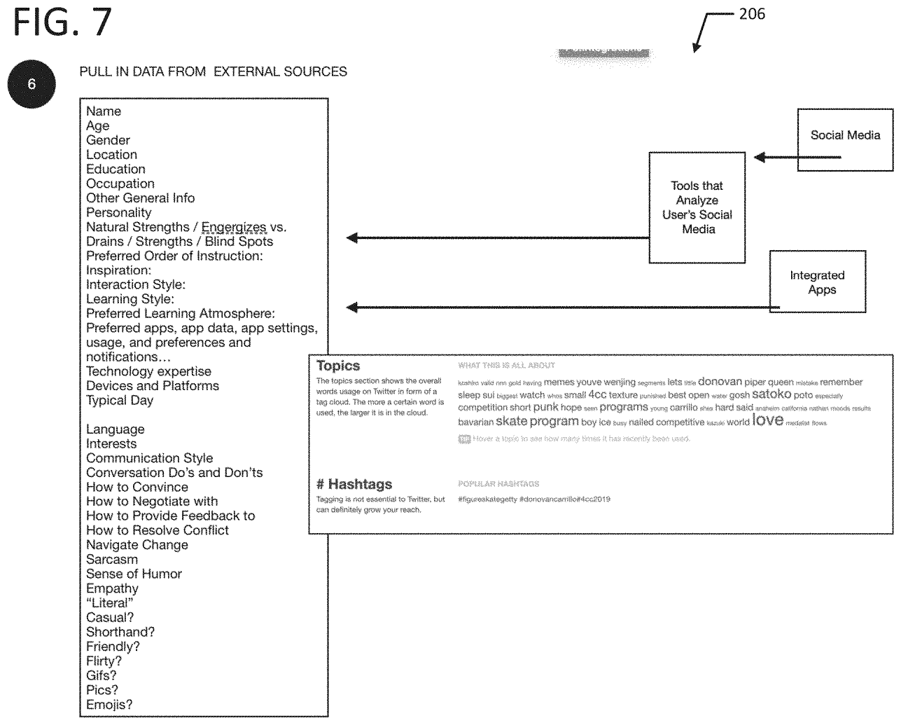

FIG. 7 illustrates additional details regarding inputting 206 data from external sources by the bot service 108.

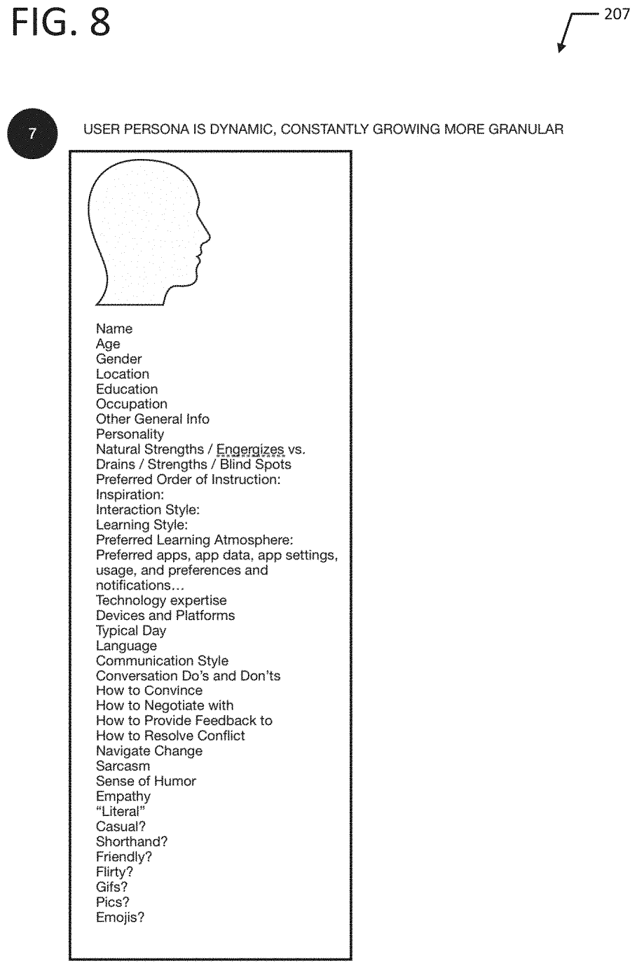

FIG. 8 illustrates additional details regarding generation 207 of a user persona by the bot service 108. In an embodiment, the user personas are dynamic and the bot service 108 constantly increases the granularity of the personas based on additional information and/or interactions with the user.

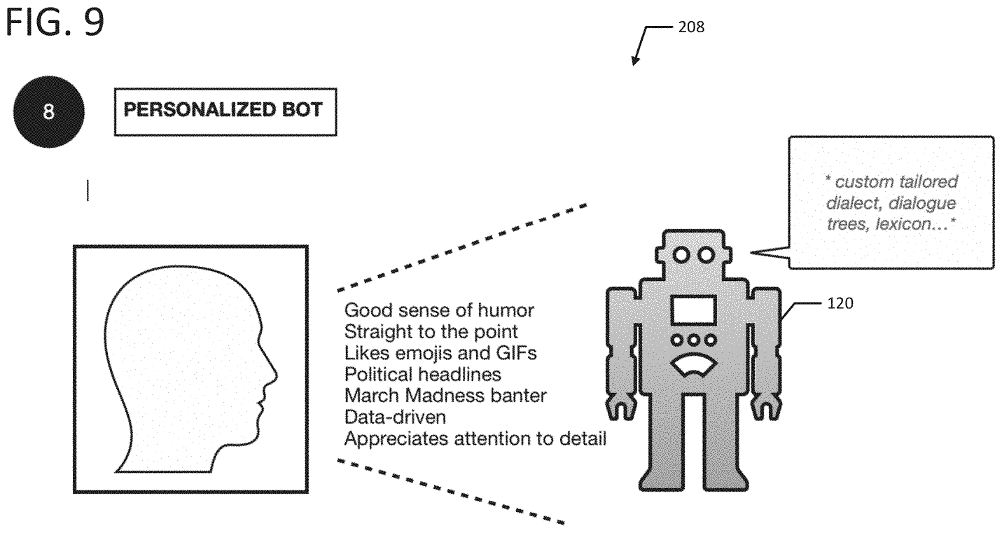

FIG. 9 illustrates additional details regarding interactions 208 of the personalized bot 120 with the user. For example, the personalized bot 120 utilizes the user persona to custom tailor aspects of the interaction (e.g., dialect, dialogue, lexicon, etc.) to the particular user.

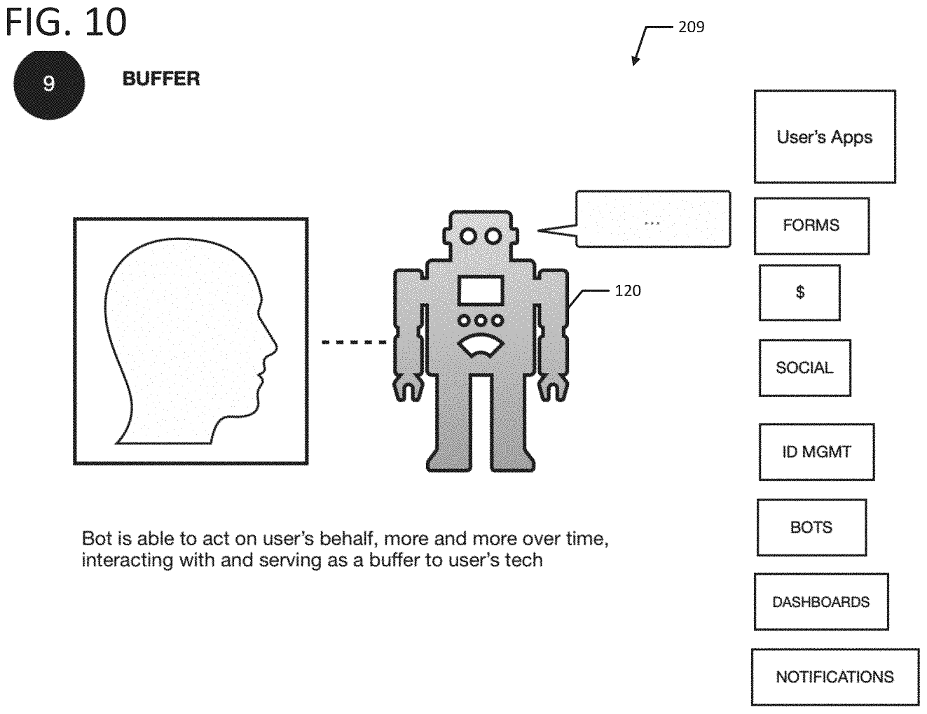

FIG. 10 illustrates additional details regarding the personalized bot 120 functioning as a buffer 209 for the user.

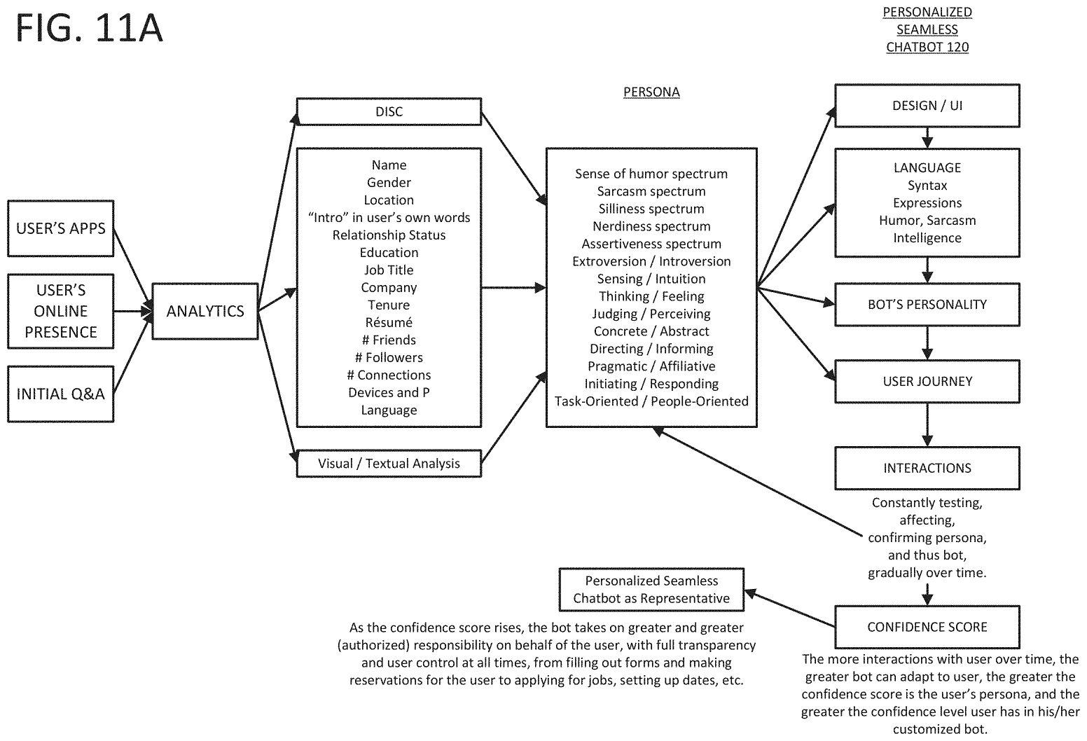

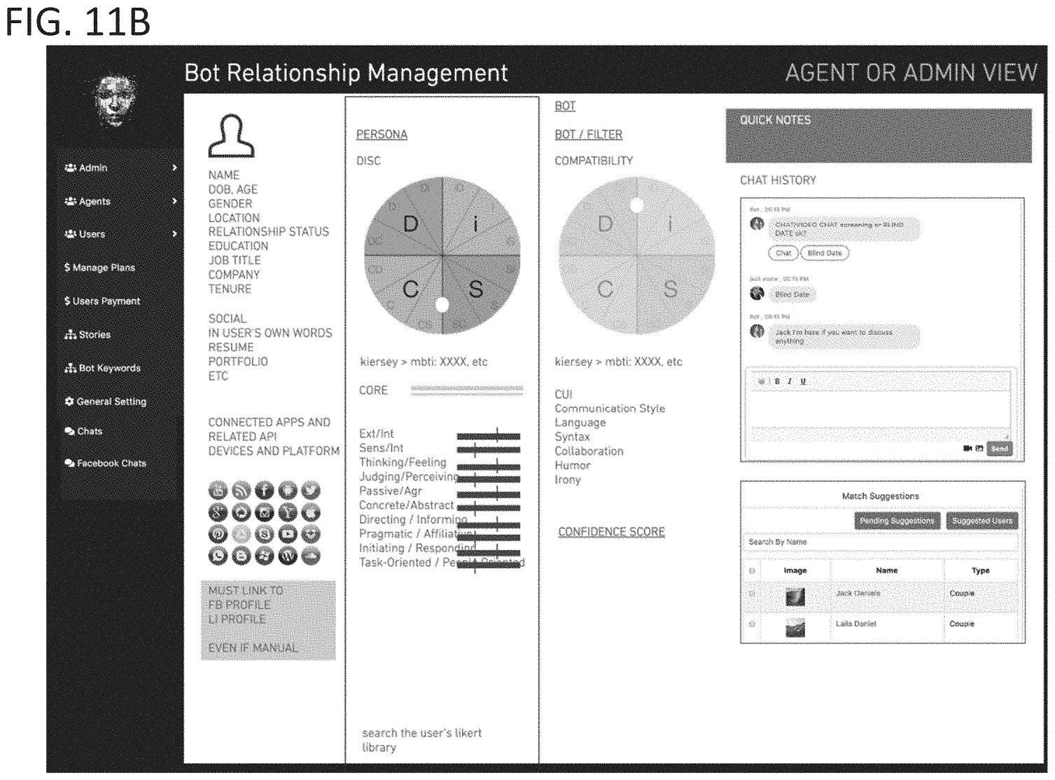

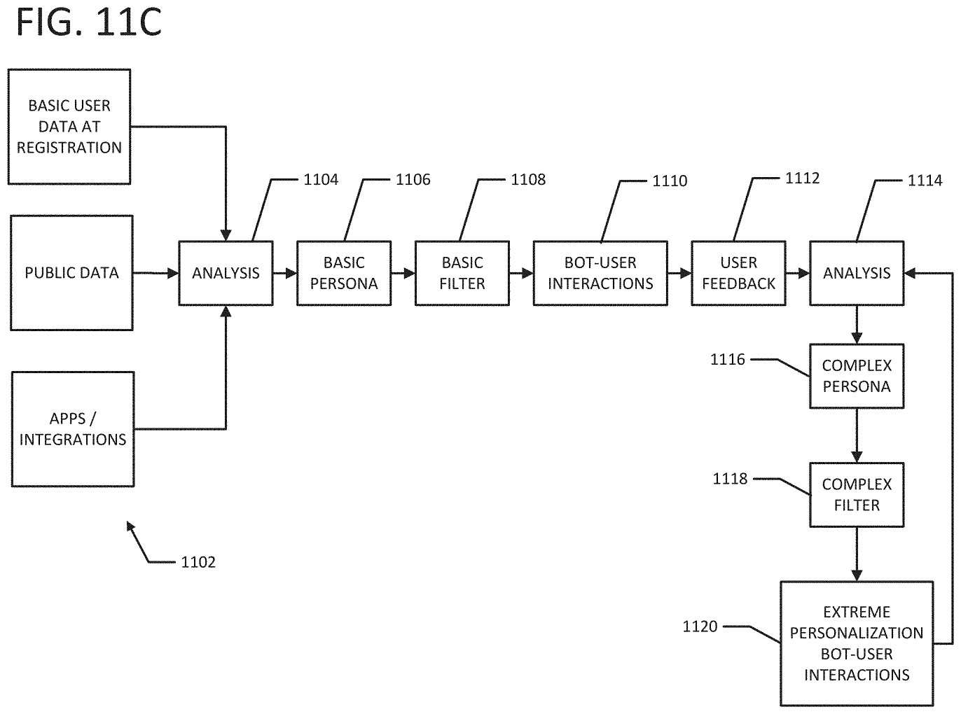

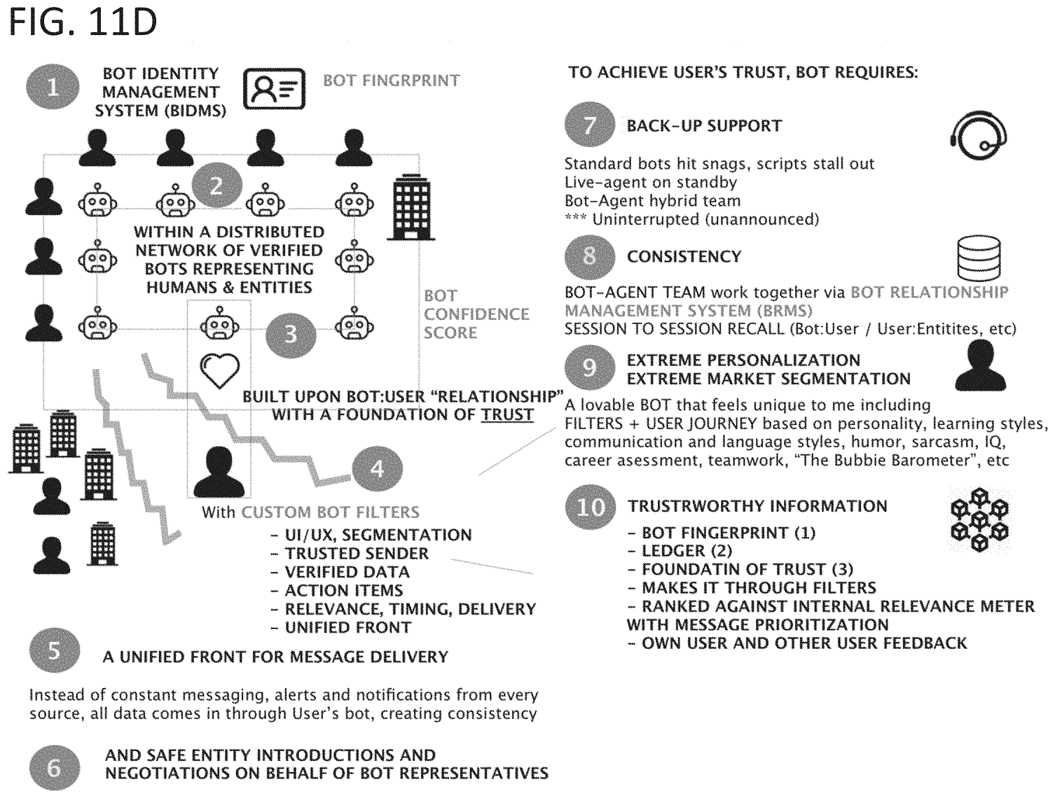

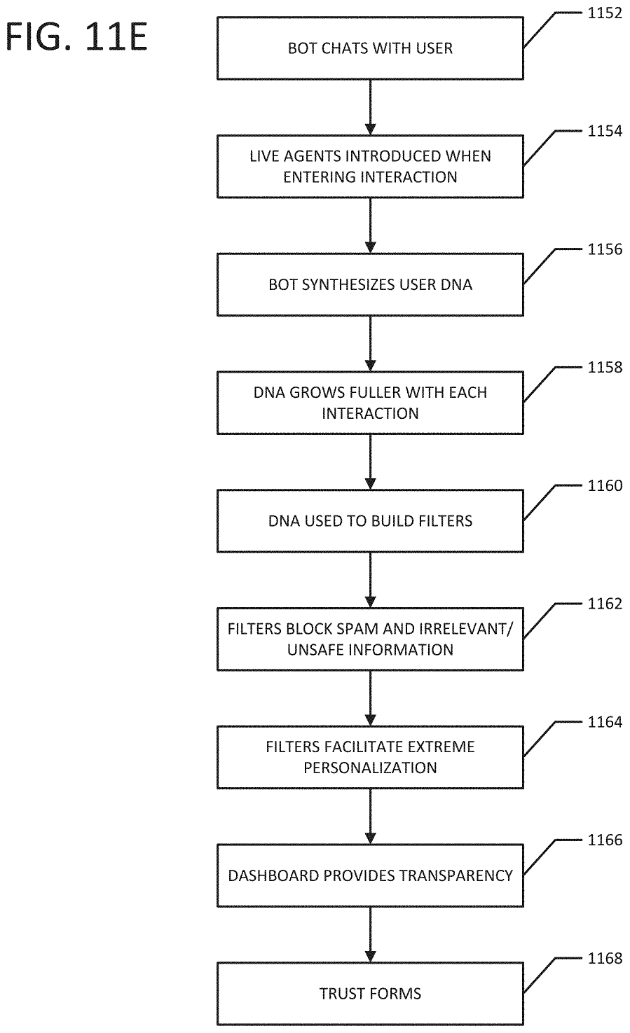

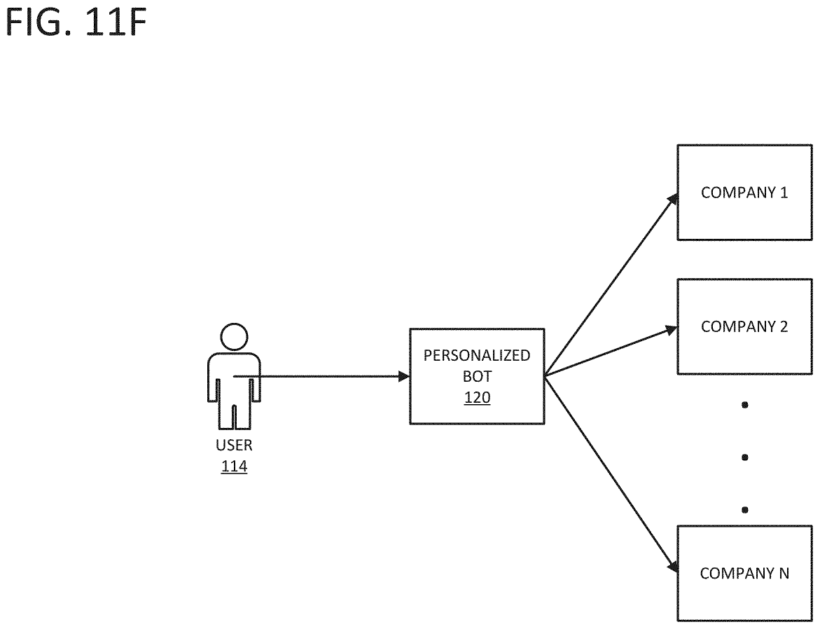

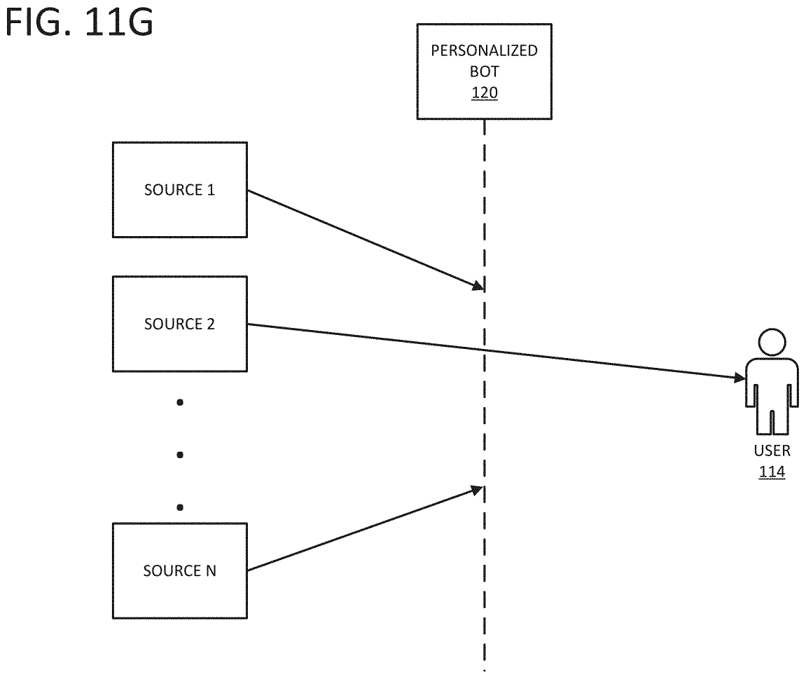

FIG. 11A illustrates another exemplary embodiment of system 100 and associated methods performed by system 100 for providing the personalized bot 120. By registering for the bot service 108, the bot service 108 gets access to the user's online presence and apps (e.g., via a Facebook login alone, for example) and can thus get data for analytics. The bot service 108 can additionally or alternatively ask the user one or more questions at signup. From there, the bot service 108 creates three buckets—what it can derive from those initial analytics. The bot service 108 creates a DISC hypothesis and MBTI hypothesis, gathers the demographic information of the user, and conducts a visual and/or textual analysis of the user's online presence. For this information, the bot service 108 generates the user's persona. In an embodiment, each item is a scale (i.e., a spectrum of possible values), the persona includes a group of scales or spectra. Based on the user's detailed persona created, the bot service 108 creates a personalized bot 120 for the user. In an embodiment, the personalized bot 120 includes a custom design / user interface (e.g., colors, sizes, layout, etc.), language, bot personality, user journey (e.g., script, corresponding branch logic, etc.), and the like. The personalized bot 120 and the user interact. The personalized bot 120 chats based on its personality, which is based on the user's persona. All interactions serve to test and affect, edit and confirm the user's persona. Each interaction has corresponding points on the persona scales. So, for instance, if the personalized bot 120 asks a user “How many books have you read in the past week?” and the user answers “5” then that may add a point to “introversion” and a point to “nerdiness” so certain scales will be altered with certain interactions. The beginning point of the scales is determined based on the initial analytics. The personalized bot 120 changes the scales accordingly based on interactions with the user.

FIG. 11B illustrates an exemplary graphical user interface an agent or administrator view of the a personalized bot 120 for a user 114. The graphical user interface includes graphical elements for information about the user, technology (e.g., connected apps, APIs, devices, platforms, etc.) utilized by the user, a user persona for the user, the bot or filter, an interaction history, notes, and match suggestions.

In an embodiment, the personalized bot 120 developed for a particular user may be a filter (e.g., a custom bot filter for extreme personalization), as further described herein, for personalizing its properties and the properties of its interactions with the user into form(s) most compatible to the user's persona, communication style, and learning style and for integrating and filtering live agent commands and third party intelligence and actions through a seamless uninterrupted personalized bot experience. Referring to FIG. 11C, the personalized bot 120 may “extremely personalize” communications and/or interactions to the particular user. By way of non-limiting example, the personalized bot 120 may communicate with the user via emojis, animated GIFs, memes, or the like when those forms of communication are more personalized to the user's persona compared to standard text communications. In exemplary embodiments, the extreme personalization of interactions may be based on characteristics of the user described herein such as MBTI, DISC, and the like.

Extreme personalization includes tailoring the message itself, delivery method, and style in accordance with an embodiment. At 1102, the bot service 108 gathers data. Exemplary data includes, but is not limited to, user data at registration (e.g., name, demographics, relationships, education, career, etc.), public data (e.g., social media, blogs, articles, resumes, etc), and data from apps and integrations. At 1104, the bot service 108 analyzes the gathered data. The bot service 108 creates a basic persona at 1106. The basic persona includes, but is not limited to, personality (e.g., Likert scales, etc), technology profile, communication style, learning style, and the like. At 1108, the hot service 108 creates a basic filter, The basic filter includes, but is not limited to, the message itself, the bot's confidence in message reception, suppression of unwanted or likely unwanted messages, inclusion of wanted or likely wanted messages, prioritization of messages (e.g., including based on statistics, user profile, trends, interactions, etc.), message style (e.g., language, CUL etc), and delivery preferences (e.g., time, notification types, etc.). In an embodiment, the bot service 108 utilizing the basic persona and/or basic filter comprises the personalized bot 120. For example, the bot service 108 utilizing the active filter (i.e., a personalized bot 120) interacts with the user at 1110. The personalized bot 120 gathers user feedback and/or responses at 1112. In an embodiment, feedback is an up vote or a down vote. The personalized hot 120 analyzes the feedback and/or responses at 1114. The personalized bot 120 creates a complex persona at 1116 and creates a complex filter at 1118. At 1120, the personalized bot 120 provides extreme personalization via continued bot-user interactions with an infinite feedback loop (e.g., feedback 4 analysis 4 tweak interactions→feedback, etc.) and validated data from validated sources and/or users.

With reference to FIG. 11D, further aspects of an embodiment are illustrated and described. In an embodiment, a distributed network of verified bot representatives for humans and entities built upon symbiotic bot:user relationships in accordance with an example embodiment is illustrated. The bots comprise a bot identity management system (BIDMS) and include a bot fingerprint. The bot serves as a representative for the user in the BIDMS and also confirms a bot fingerprint match of another person or entity when interacting on the user's behalf. The bot fingerprint provides for person recognition using the user's highly specialized minutiae including, but not limited to, behavioral traits (e.g., typing rhythm, gait, voice, etc.) and chat stylometry analysis (e.g., word choice, sentence structure, syntax, punctuation, etc.). In an aspect, a distributed network of verified bot representatives for humans and entities is included. In another aspect, the distributed network of verified bot representatives is built upon a true symbiotic bot:user “relationship.” In an embodiment, a symbiotic relationship requires trust, which can be determined based on the user confidence score in the bot. The confidence score can include an illusion measurement, which measures how the bot is maintaining the illusion (e.g., from the user's perspective) of being independent against several metrics including, but not limited to, response times, CUI/X, consistency, personalization (e.g., the uniqueness of the user's specific filters, etc.), user engagement, and user feedback. Other metrics factored in to the bot confidence score include, but are not limited to, trust and behavioral factors (e.g., skepticism of individual user or user segment, etc.). Additionally or alternatively, the trust requires a user-personalized bot.

In an aspect, the bot is reliable (e.g., live agent/bot hybrid). In another aspect, the bot is consistent (e.g., powered by a bot relationship management system (BRMS)). In a further aspect, the bot is extremely personalized to the related user (e.g., includes MBTI filters, user interface/user experience (UI/UX), etc.). In an aspect, the bot is user-friendly (e.g., per the user's learning style, language and communication styles, meets the “bubbie barometer”, etc.). In another aspect, the bot is a trustworthy source of information for the related user. In an aspect, the information provided by the bot is verified. For example, the verification can occur via a distributed ledger (e.g., a blockchain system, etc.). In an aspect, the information provided by the bot is relevant and of interest to the user (e.g., based on internal relevance meter, message prioritization, etc.).

In an embodiment, the distributed network includes one bot per verified human/entity. In the distributed network, the bots communicate and protect the user/entities' identities. In an exemplary and non-limiting embodiment, if User A wants to meet User B for a date, User A's bot checks with User B's bot to find out if User B meets User A's verification requirements. Likewise, User B's bot checks with User A's bot to find out if User A meets User B's verification requirements. When the connection is not made it dies with the bots so the user do not find out the reason why the connection was not made (e.g., User B has a property/characteristic that is undesirable to User A, etc.). Extensions of the above concept to other connections between two or more users (e.g., job interviews, meetings, etc.) are within the scope of the invention.

In an embodiment, the distributed ledger requires a multi-level security and ID verification process. The user will be able to verify as much information as they choose to verify. Throughout, the user manages their data, though once it is in the ledger it is in the ledger. But referring again to the example above, User B may elect to share that information but only via the distributed ledger (e.g., blockchain) because User B actually wants to find someone who has the same undesirable property/characteristic or someone who does not find the property/characteristic undesirable. This concept may be extended to other areas, such as background checks and the like. The more a user verifies itself the more opportunities the user will get. In an embodiment, the bot is operable to assure the user that it only provides trustworthy information. That includes verified information—verified that it is not spam, verified against the Bot ledger if possible but relevance is also important.

### Verification

-Ledger/verified sender

-“INTERNAL RELEVANCE METER WITH MESSAGE PRIORITIZATION”pulls data from the user persona, filters, and the like to determine how relevant the information is and prioritize it accordingly. In some embodiments, the data that the bot filters out is just as important if not more important than the data it presents to a user. The bot is an active filter not only in UI/UX, but in that once the bot knows/understands its related user, the bot innately knows:
what to absolutely filter out
what the present, but only the user is bored and looking for something to read
what to present immediately
what to present with a bit of a “gentle touch” for sensitive information or based on MBTI, etc.

With reference to FIG. 11E, further aspects of an embodiment of a chatbot filter for safe interactions are illustrated and described. For example, the chatbot filter can ensure certain safety parameters are met within the interaction (e.g., conversation) by filtering comments, administering warnings, shutting down the interaction, and the like. In an aspect, the chatbot filter may be utilized in a human resources context. For example, inappropriate questions during a job interview or application process can be integrated into the bot logic (e.g., bot logic 124) and trigger the consequences (e.g., filtering comments, administering warnings, shutting down the interaction, etc.). In another aspect, the chatbot filter may be utilized in a cannabis context. For example, the bot logic can utilize the user's location and local laws to determine whether certain interaction content is appropriate. In a further aspect, the chatbot filter may be utilized in a dating context. For example, the bot logic can flag inappropriate conduct.

At 1152, the personalized bot 120 interacts with the user 114. In an embodiment, the interactions are platform agnostic and can occur via chat, short message service messages, email, web interface, or the like. At 1154, a live agent 112 can be included in the interaction and the personalized bot 120 introduces the live agent upon entrance. At 1156, the personalized bot 120 synthesizes the user DNA. For example, the bot can synthesize the user DNA using text analysis from chat transcripts, social media and public data, data from connected apps, natural language processing, speech patterns, and the like. At 1158, the user DNA grows fuller with each interaction with the user 114. For example, the personalized bot 120 can recall interactions between sessions and devices. At 1160, the user DNA is utilized to build one or more filters for the user 114. At 1162, the filters operate to block spam and irrelevant and/or unsafe information from reaching the user 114. In an embodiment, the filters provide a level of safety to the user's interactions. As explained above, the filters can vary based on industry and circumstance (e.g., age requirements, local government regulations, etc.). At 1164, the filters operate to facilitate extreme personalization of the personalized bot 120 to the user 114. For example, extreme personalization includes the personalized bot 120 understanding exactly how, when, and where to communicate with the user 114, the personalized bot 120 building a relationship with the user 114, hyper-personalizing user outreach to speak directly to the user's needs and motivations and build trust through authenticity, the personalized bot 120 continues to learn about the user 114 over time. At 1166, a dashboard (e.g., the graphical user interface dashboard illustrated in FIG. 11B, etc.) provides transparency into the bot-user relationship. The dashboard provides information about information that the personalized bot 120 stores and shares. The user 114 can utilize the dashboard to set privacy and sharing settings. At 1168, the user 114 develops trust in the personalized bot 120 over time. For example, the user 114 can trust that messages delivered by the personalized bot 120 are on-target and well positioned. When the user trusts the personalized bot 120, the personalized bot 120 can communicate and operate on the user's behalf to other users, bots, apps, agencies, and the like.

In an aspect, the chatbot filter is a highly effective recommendation engine. In another aspect, the chatbot filter provides intelligent targeting. In some embodiments, the chatbot filter can be utilized internally by a business entity to assist employees with staffing and hiring, onboarding and training, internal communications and tasks (e.g., meeting scheduling, etc.), interdepartmental communications, as a management tool, to access company information more quickly and intuitively through the bot, as a customer relationship management tool, as a human resources tool, and the like. In some embodiments, the chatbot filter can be utilized externally by a business entity to assist with public relations, marketing, brand outreach, brand awareness, recruitment, lead generation, business to business (B2B) partnerships, safety and confidentiality, and the like. An employee who works with a bot (e.g., bot service 108, personalized bot 120) may be referred to as a botist in accordance with aspects of the present invention. In further embodiments, the chatbot filter can be utilized by individuals for protection and confidentiality, well-tailored product and service recommendations, introductions for personal relationships, and the like.

FIG. 11F illustrates an example embodiment of the chatbot filter in a job search context. In this embodiment, the personalized bot 120 knows the user 114 and represents the user as an employee candidate to multiple companies. In contrast, conventional techniques require the user 114 to manually represent himself or herself to the multiple companies.

FIG. 11G illustrates an example embodiment of the chatbot filter in a marketing context. In this embodiment, the personalized bot 120 knows the user 114 and passes through to the user only messages from sources (e.g., Source 2) that the personalized bot 120 determines are relevant to the user 114. Furthermore, the personalized bot 120 determines how and when to deliver the relevant messaging to the user 114 in accordance with the user's persona (e.g., the user's personal preferences). In contrast, conventional techniques allow all messaging (including irrelevant messages) to be presented to the user, resulting in constant, off-target messaging.

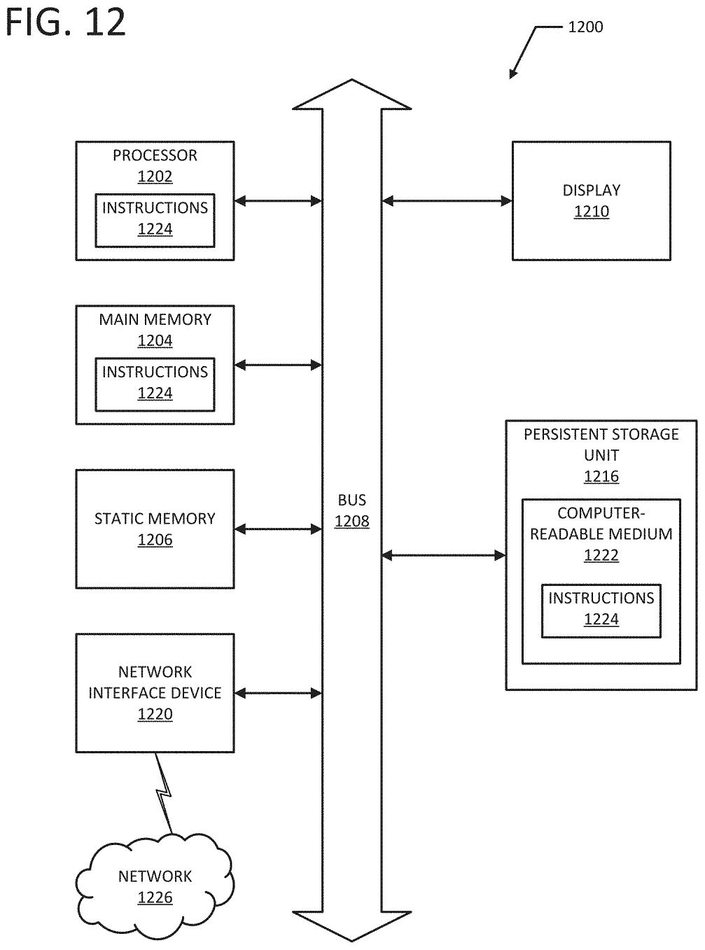

With reference to FIG. 12, an example embodiment extends to a machine in the example form of a computer system 1200 within which instructions for causing the machine to perform any one or more of the methodologies discussed herein may be executed. For example, the computer system 1200 may comprise the user computing devices 102, the server computing devices 106, and/or the live agent device 112. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The exemplary computer system 1200 may include a processor 1202 (e.g., a central processing unit (CPU), a graphics processing unit (GPU) or both), a main memory 1204 and a static memory 1206, which communicate with each other via a bus 1208. The computer system 1200 may further include a touchscreen display unit 1210. In example embodiments, the computer system 1200 also includes a network interface device 1220.

The persistent storage unit 1216 includes a machine-readable medium 1222 on which is stored one or more sets of instructions 1224 and data structures (e.g., software instructions) embodying or used by any one or more of the methodologies or functions described herein. For example, the one or more sets of instructions 1224 may comprise, in whole or in part, the bot service 108, the data source services 110, and/or aspects of the personalized bot 120. The instructions 1224 may also reside, completely or at least partially, within the main memory 1204 or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks. A machine-readable storage medium does not include signals.

The instructions 1224 may further be transmitted or received over a communications network 1226 using a signal transmission medium via the network interface device 1220 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). In some embodiments, the communications network 1226 may comprise, in whole or in part, the network 104. The term “machine-readable signal medium” shall be taken to include any transitory intangible medium that is capable of storing, encoding, or carrying instructions for execution by the machine, and includes digital or analog communications signals or other intangible medium to facilitate communication of such software.

In an aspect, a method is provided that includes a bot service (e.g., bot service 108, etc.) executing on a server computing device (e.g., server computing device 106, computer system 1200, etc.) receiving user data. The user data includes data representing an online presence of a user (e.g., data from APIs 130, apps 132, databases 134, etc.). The bot service analyzes the user data and generates a personality hypothesis for the user based on the analyzed user data. The bot service creates a user persona for the user based at least in part on the generated personality hypothesis. The bot service creates a personalized bot (e.g., personalized bot 120, etc.) for the user based on the user persona. The personalized bot personalizes at least a user interface, a language, a personality, and a user journey specifically to the user. The bot service continually updates the personalized bot based on interactions between the personalized bot and the user.

In some embodiments, the method further includes updating the personalized bot based on interactions between the user and a live agent (e.g., live agent 112, etc.). In further embodiments, the personalized bot includes one or more machine learning algorithms (e.g., machine learning algorithms 126, etc.) and updating the personalized bot includes updating a model of the machine learning algorithms. In yet further embodiments, the personality hypothesis includes a Myers-Briggs Type Indicator. In further embodiments, the user data includes social media data. In yet further embodiments, the user persona includes a plurality of properties and each property includes a value on a spectrum.

In another aspect, a method is provided that includes a bot service (e.g., bot service 108, etc.) executing on a server computing device (e.g., server computing device 106, computer system 1200, etc.) receive user data from a user (e.g., via user device 102, etc.). The bot service creates a user persona for the user based on the received user data. The bot service analyzes the received user data to determine at least one communication style of the user and at least one learning style of the user. The bot service creates a personalized bot (e.g., personalized bot 120, etc.) for the user based on the user persona, the communication style of the user, and the learning style of the user. The method further includes filtering interactions between the personalized bot and the user. The filtering includes altering one or more properties of the interactions such that the interactions are compatible with the user persona, the communication style of the user, and the learning style of the user. The personalized bot interacts with the user via the filtered interactions.

In some embodiments, the method further includes continually updating the personalized bot based on the filtered interactions between the personalized bot and the user. In further embodiments, the personalized bot includes one or more machine learning algorithms (e.g., machine learning algorithms 126, etc.) and updating the personalized bot includes updating a model of the machine learning algorithms. In yet further embodiments, the method further includes updating the personalized bot based on interactions between the user and a live agent (e.g., live agent 112, etc.). In further embodiments, the user data includes social media data. In yet further embodiments, the user persona includes a plurality of properties and each property includes a value on a spectrum. In some embodiments, the method further includes the bot service providing a dashboard to the user, and the dashboard is operable to present data about information stored and shared by the personalized bot.

In yet another aspect, a system is provided that includes at least one processor (e.g., processor 1202, etc.) and at least one non-transitory computer-readable storage medium (e.g., main memory 1204, computer-readable medium 1222, etc.). The storage medium stores one or more processor-executable instructions (e.g., instructions 1224, etc.) that, when executed by the at least one processor, provide a bot service (e.g., bot service 108, etc.). The bot service is configured to receive user data from a user and create a user persona for the user based on the received user data. The bot service is also configured to analyze the received user data to determine at least one communication style of the user and at least one learning style of the user. The bot service is further configured to create a personalized bot (e.g., personalized bot 120, etc.) for the user based on the user persona, the communication style of the user, and the learning style of the user. The bot server is configured to filter interactions between the personalized bot and the user. The filtering includes altering one or more properties of the interactions such that the interactions are compatible with the user persona, the communication style of the user, and the learning style of the user. The personalized bot interacts with the user via the filtered interactions.

Although an overview of the inventive subject matter has been described with reference to specific example embodiments, various modifications and changes may be made to these embodiments without departing from the broader scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art.

What is claimed is:

1. A method, comprising:
receiving, by a bot service executing on a server computing device, user data, wherein the user data includes data representing an online presence of a user;
analyzing, by the bot service, the user data;
generating, by the bot service, a personality hypothesis for the user based on the analyzed user data;
creating, by the bot service, a user persona for the user based at least in part on the generated personality hypothesis;
creating, by the bot service, a personalized bot for the user based on the user persona, wherein the personalized bot personalizes at least a user interface, a language, a personality, and a user journey specifically to the user; and
continually updating, by the bot service, the personalized bot based on interactions between the personalized bot and the user.

2. The method of claim 1, further comprising updating the personalized bot based on interactions between the user and a live agent.

3. The method of claim 1, wherein the personalized bot includes one or more machine learning algorithms, and wherein said updating the personalized bot includes updating a model of the machine learning algorithms.

4. The method of claim 1, wherein the personality hypothesis includes a Myers-Briggs Type Indicator.

5. The method of claim 1, wherein the user data includes social media data.

6. The method of claim 1, wherein the user persona includes a plurality of properties, and wherein each property of the plurality of properties includes a value on a spectrum.

7. A method, comprising:
receiving, by a bot service executing on a server computing device, user data from a user;
creating, by the bot service, a user persona for the user based on the received user data;
analyzing, by the bot service, the received user data to determine at least one communication style of the user and at least one learning style of the user;
creating, by the bot service, a personalized bot for the user based on the user persona, the communication style of the user, and the learning style of the user;
filtering interactions between the personalized bot and the user, wherein said filtering comprises altering one or more properties of the interactions such that the interactions are compatible with the user persona, the communication style of the user, and the learning style of the user; and
interacting, by the personalized bot, with the user via the filtered interactions.

8. The method of claim 7, further comprising continually updating the personalized bot based on the filtered interactions between the personalized bot and the user.

9. The method of claim 8, wherein the personalized bot includes one or more machine learning algorithms, and wherein said updating the personalized bot includes updating a model of the machine learning algorithms.

10. The method of claim 7, further comprising updating the personalized bot based on interactions between the user and a live agent.

11. The method of claim 7, wherein the user data includes social media data.

12. The method of claim 7, wherein the user persona includes a plurality of properties, and wherein each property of the plurality of properties includes a value on a spectrum.

13. The method of claim 7, further comprising providing, by the bot service, a dashboard to the user, wherein the dashboard is operable to present data about information stored and shared by the personalized bot.

14. A system, comprising:
at least one processor; and
at least one non-transitory computer-readable storage medium storing one or more processor-executable instructions that, when executed by the at least one processor, provide a bot service configured to:
receive user data from a user;
create a user persona for the user based on the received user data;
analyze the received user data to determine at least one communication style of the user and at least one learning style of the user;
create a personalized bot for the user based on the user persona, the communication style of the user, and the learning style of the user;
filter interactions between the personalized bot and the user, wherein said filtering comprises altering one or more properties of the interactions such that the interactions are compatible with the user persona, the communication style of the user, and the learning style of the user; and
interacting, by the personalized bot, with the user via the filtered interactions.

15. The system of claim 14, wherein the bot service is further configured to continually update the personalized bot based on the filtered interactions between the personalized bot and the user.

16. The system of claim 15, wherein the personalized bot includes one or more machine learning algorithms, and wherein said updating the personalized bot includes updating a model of the machine learning algorithms.

17. The system of claim 14, wherein the bot service is further configured to update the personalized bot based on interactions between the user and a live agent.

18. The system of claim 14, wherein the user data includes social media data.

19. The system of claim 14, wherein the user persona includes a plurality of properties, and wherein each property of the plurality of properties includes a value on a spectrum.

20. The system of claim 14, wherein the bot service is further configured to provide a dashboard to the user, wherein the dashboard is operable to present data about information stored and shared by the personalized bot.
